(19) United States
(12) Patent Application Publication
(10) Pub. No.: US 2025/0314011 A1
(43) Pub. Date: Oct. 9, 2025

(54) SHEET MANUFACTURING APPARATUS

(71) Applicant: SEIKO EPSON CORPORATION, Tokyo (JP)

(72) Inventors: Takehiro KOBAYASHI, Matsumoto (JP); Akira ANAMI, Kitakyushu (JP)

(21) Appl. No.: 19/096,804

(22) Filed: Apr. 1, 2025

(30) Foreign Application Priority Data
Apr. 3, 2024 (JP) 2024-060023

(51) Int. Cl. D21B 1/08; D21C 5/02

(52) U.S. Cl. CPC D21B 1/08; D21C 5/02

(57) ABSTRACT

A sheet manufacturing apparatus includes a storage section that stores paper pieces, a processing section that uses the paper pieces as a raw material to manufacture recycled paper through a dry process, an exterior cover, and a sealing cover that tightly closes an insertion port of the storage section. The exterior cover and the sealing cover open and close in an interlocked manner.

The present application is based on, and claims priority from JP Application Serial Number 2024-060023, filed Apr. 3, 2024, the disclosure of which is hereby incorporated by reference herein in its entirety.

### BACKGROUND

### 1. Technical Field

The present disclosure relates to sheet manufacturing apparatuses.

### 2. Related Art

Sheet manufacturing apparatuses configured to manufacture paper sheets from pieces of, for example, waste paper through a dry process have a storage section that stores paper pieces having a predetermined size which have been obtained by cutting paper with a shredder.

For example, JP-A-2011-149106 discloses a paper material supply apparatus that supplies a paper material to a waste paper recycling apparatus. This paper material supply apparatus includes a hopper that has an ejection port in a lower portion thereof and that stores a paper material such as paper pieces, and a delivery mechanism having a pair of delivery rollers disposed at the lower ejection port. This delivery mechanism is supposed to prevent the backflow of the paper material. The hopper corresponds to the storage section.

In the waste paper recycling apparatus disclosed in JP-A-2011-149106, however, the hopper is not covered with a lid. In this case, particles of the paper material stored in the storage section may be scattered to the outside.

### SUMMARY

According to an aspect of the present disclosure, a sheet manufacturing apparatus includes a storage section that stores paper pieces and a processing section that uses the paper pieces as a raw material to manufacture recycled paper through a dry process. The storage section has a lid of an openable/closable type. The lid includes an exterior cover and a sealing cover that tightly closes an insertion port of the storage section. The exterior cover and the sealing cover open and close in an interlocked manner with a biasing section therebetween.

### BRIEF DESCRIPTION OF THE DRAWINGS

FIG. 1 is a perspective view of a schematic configuration of a storage section according to Embodiment 1 of the present disclosure.

FIG. 2 is a perspective view of the storage section with a lid open.

FIG. 3 is a perspective view of the lid as viewed from a sealing cover side.

FIG. 4 is a sectional view of the lid taken along line b-b of FIG. 3.

FIG. 5 is a perspective sectional view of a main section of the lid.

FIG. 6 is an enlarged perspective view of a first engaging section and some surrounding components.

FIG. 7 is an enlarged perspective view of a second engaging section and some surrounding components.

FIG. 8 is an enlarged perspective view of the second engaging section and some surrounding components with a third member removed.

FIG. 9 is a perspective sectional view of a packing section and some surrounding components.

FIG. 10 is a schematic configuration diagram of a sheet manufacturing apparatus.

### DESCRIPTION OF EMBODIMENTS

### Embodiment 1

### Overview of Storage Section

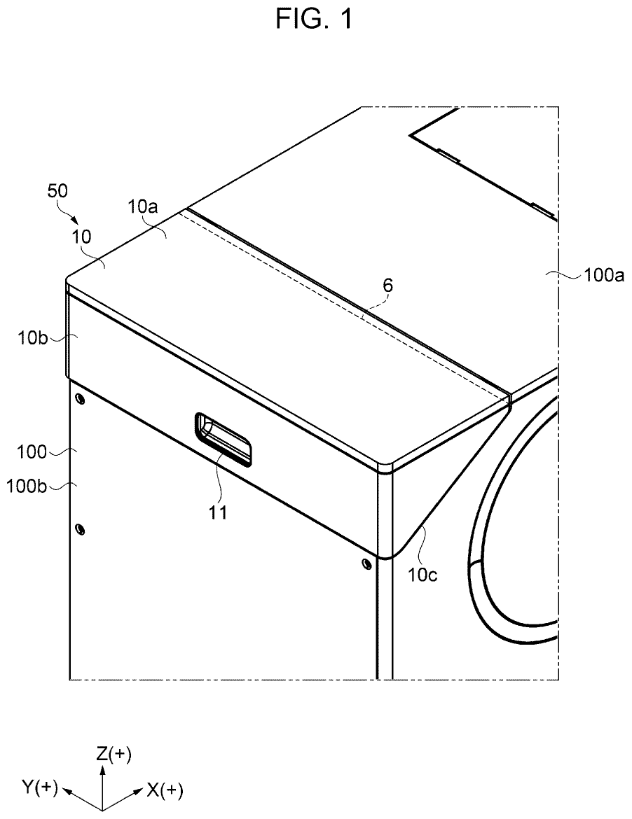

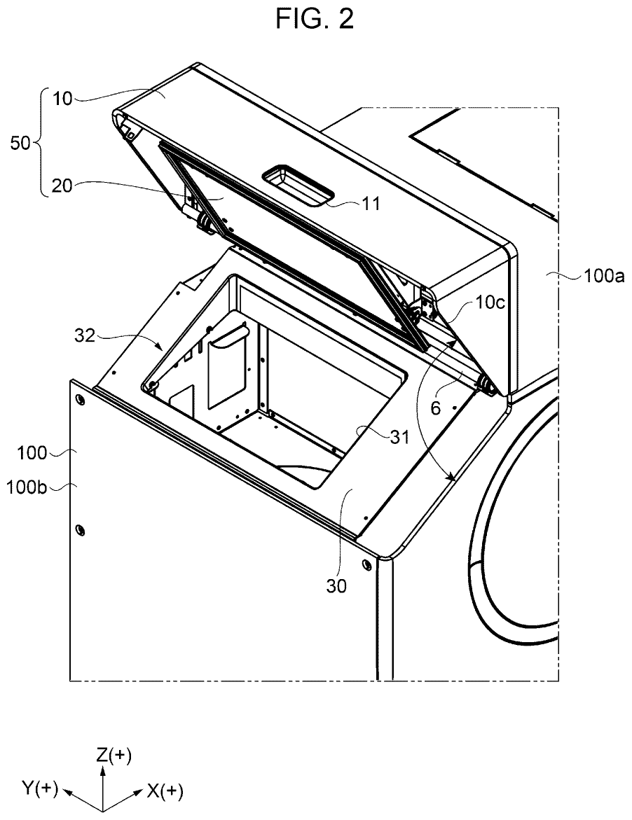

FIG. 1 is a perspective view of a schematic configuration of a lid 50 and some surrounding components of the lid 50 according to Embodiment 1 of the present disclosure. FIG. 2 is a perspective view of the lid 50 in an open state and some surrounding components of the lid 50.

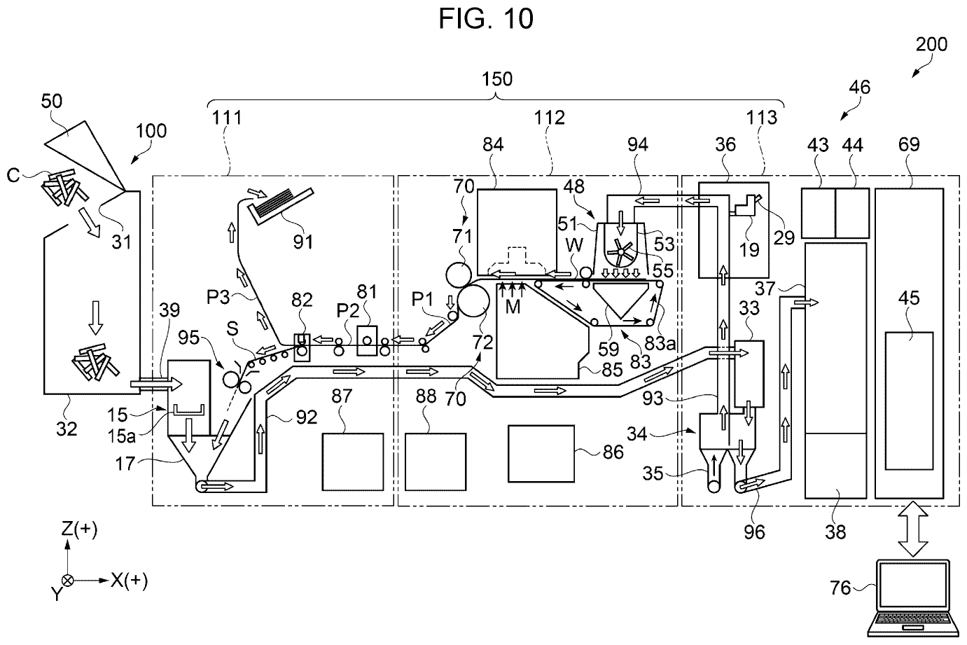

In this embodiment, the storage section 100 is a storage section in a sheet manufacturing apparatus 200 (see FIG. 10) that manufactures paper sheets from pieces of, for example, waste paper through a dry process. The storage section 100 stores paper pieces as a raw material. Details of the sheet manufacturing apparatus 200 will be described later.

A schematic configuration of the storage section 100 according to this embodiment will be described with reference to the accompanying drawings. Each of these drawings illustrates the three mutually orthogonal axes: an X-axis, a Y-axis, and a Z-axis. In this embodiment, the height direction of the storage section 100 is defined as the +Z direction. Further, the direction along the X-axis is defined as the X direction, the direction along the Y-axis is defined as the Y direction, and the direction along the Z-axis is defined as the Z direction. For example, the Z direction includes the +Z direction and the −Z direction. In this embodiment, the Z direction coincides with the vertical direction. Furthermore, the +Z direction is also referred to as the upper direction, whereas the −Z direction is also referred to as the lower direction. In some drawings, dimensions and scales are different from the actual ones for the purpose of helping to understand the description.

The storage section 100, which has a rectangular parallelepiped shape, is provided with a lid 50 positioned along the −X-direction side of an upper surface 100a of the storage section 100. The lid 50 has a rectangular shape with the long side thereof extending in the Y direction as viewed from the −X-direction side. The lid 50 has a handle 11 at the center thereof. The lid 50 also has a right-angled triangular shape as viewed from the −Y-direction side. In addition, a rotation shaft 6 is provided at one of the acute-angled portions of the lid 50.

The lid 50 has a lid upper surface 10a and a lid front surface 10b. The lid upper surface 10a is flush with the upper surface 100a of the storage section 100, and the lid front surface 10b is flush with a front surface 100b of the storage section 100, when the lid 50 is closed.

As illustrated in FIG. 2, the lid 50 can be opened and closed by being rotated around the rotation shaft 6. A user can open or close the lid 50 by hooking their finger into the handle 11 and moving the handle 11 in the upward or downward direction. In other words, the storage section 100 includes the lid 50 of an openable/closable type.

The storage section 100 is provided with a top plate 30 in an upper portion thereof as viewed in an open state of the lid 50. The top plate 30 is a planar member made of a magnetic material; for example, the top plate 30 is a steel plate. It should be noted that the shape of the top plate 30 is not limited to a plate shape. The top plate 30 is inclined with respect to the upper surface 100a of the storage section 100 and is provided with an insertion port 31 of a rectangular shape. The long side of insertion port 31 extends in the Y direction.

The insertion port 31 leads to the inside of a storage chamber 32 in which paper pieces are stored. Via the insertion port 31, paper pieces can be introduced into the storage chamber 32. The top plate 30 with the insertion port 31 is made of a magnetic material. The inside of the storage chamber 32 may be maintained at a predetermined humidity, details of which will be described later.

The lid 50 includes an exterior cover 10, a sealing cover 20, and some other components.

As illustrated in FIG. 1, the exterior cover 10 is designed so as to form a continuous surface together with the exterior of the storage section 100. As illustrated in FIG. 2, the sealing cover 20 is an inner lid, which is disposed along a lid lower surface 10c of the exterior cover 10 having the right-angled triangular shape. The sealing cover 20 has a rectangular shape that is slightly larger than the insertion port 31.

The handle 11 is disposed on the exterior cover 10. When the exterior cover 10 is closed, the handle 11 is positioned further in the −X-direction than is the sealing cover 20 and further upward than is the end portion of the sealing cover 20 in the −X-direction.

When the lid 50 is closed, the sealing cover 20 covers the insertion port 31, and the periphery of the sealing cover 20 is brought into firm contact with the top plate 30. In other words, the lid 50 includes the exterior cover 10 and the sealing cover 20 that tightly closes the insertion port 31 of the storage section 100. Since the sealing cover 20 tightly closes the insertion port 31, the exterior cover 10 does not have to tightly cover the insertion port 31. Therefore, the design of the exterior cover 10 can be focused on the appearance rather than the functionality.

In the present disclosure, such expressions as “firm contact” and “tightly close” also refer to a state in which at least the interior of the storage chamber 32 is maintained at a predetermined humidity.

### Configuration of Lid

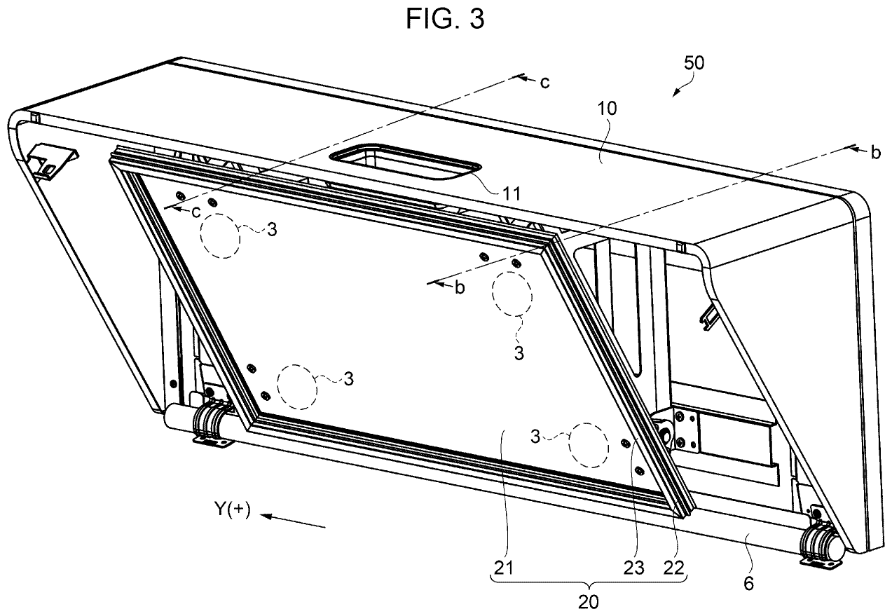

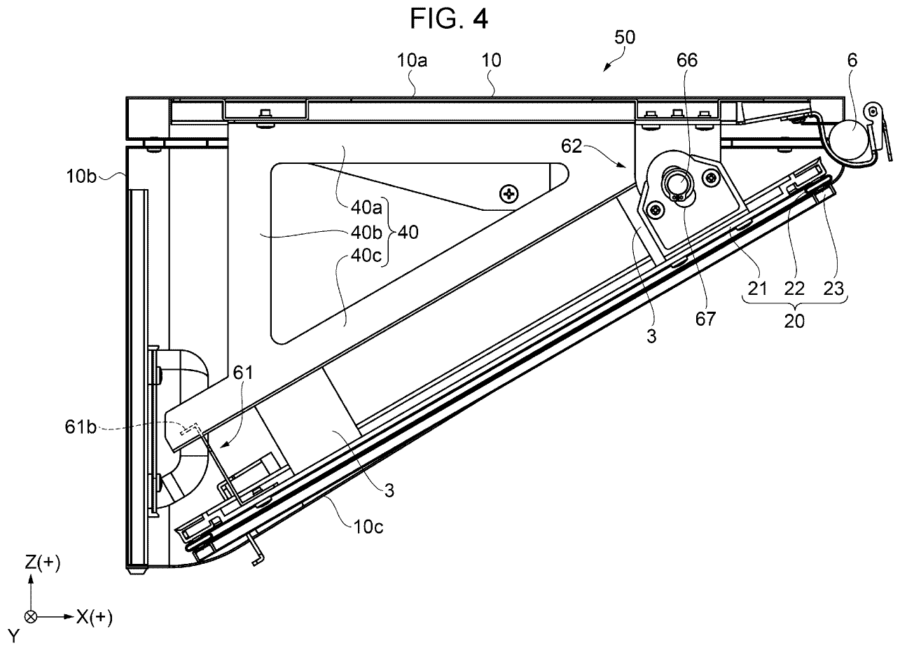

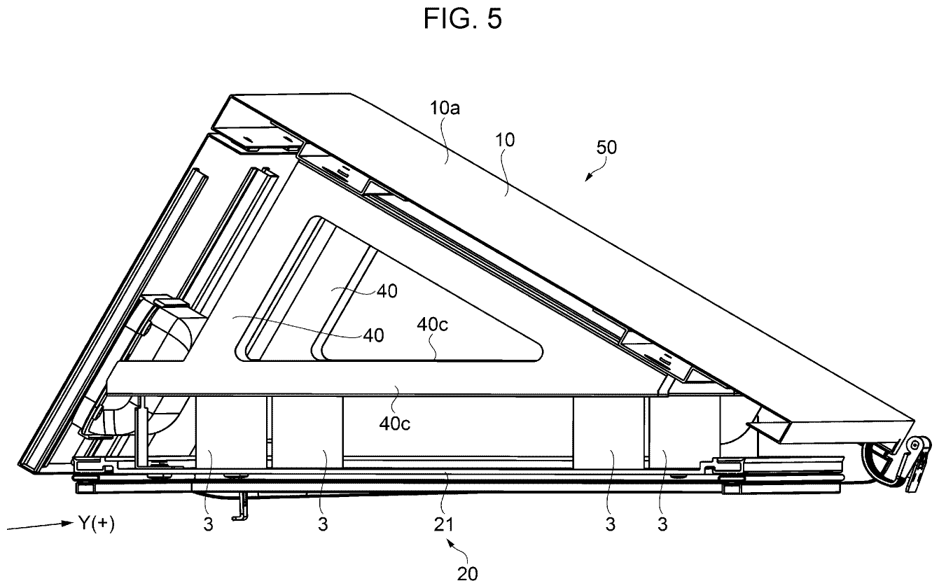

FIG. 3 is a perspective view of the lid as viewed from the sealing cover side. FIG. 4 is a sectional view of the lid taken along line b-b of FIG. 3. FIG. 5 is a perspective sectional view of the main section of the lid.

As illustrated in FIG. 3, the sealing cover 20 includes a plate section 21 to cover the insertion port 31, an abutment section 23 disposed in a frame shape on the periphery of the plate section 21, a packing section 22, and some other components.

The plate section 21 may be a plater member made of resin. However, the material of the plate section 21 is not limited to resin, and the shape thereof is also not limited. The plate section 21 may also be referred to as an insertion port cover because the plate section 21 covers the insertion port 31.

The abutment section 23 is disposed in a rectangular ring shape on the periphery of the plate section 21 and is to be brought into contact with a portion around the insertion port 31. In other words, the sealing cover 20 includes the plate section 21 to cover the insertion port 31 and the abutment section 23 provided around the plate section 21 and brought into contact with a portion around the insertion port 31. Details of the abutment section 23 and the packing section 22 will be described later.

FIG. 4 is a-sectional view of the lid 50 taken along line b-b of FIG. 3 and illustrates a structure in which the sealing cover 20 is attached to the exterior cover 10. Note that the section along line c-c of FIG. 3 is similar to the section along line b-b.

As illustrated in FIG. 4, a pair of triangular frames 40 is disposed inside the exterior cover 10. Each triangular frame 40 has a right-angled triangular shape that is slightly smaller than the exterior cover 10 of the right-angled triangular shape. Each triangular frame 40 includes a frame 40a extending along the lid upper surface 10a, a frame 40b extending along the lid front surface 10b, and a support frame 40c extending along the lid lower surface 10c. Both the triangular frames 40 are fixed to the inside of the exterior cover 10.

Two biasing sections 3 are attached to each support frame 40c. Each biasing section 3 may be a coil spring. However, each biasing section 3 is not limited to a coil spring and may be made of a rubber or elastomer.

Furthermore, each biasing section 3 may be biased by gravity, instead of the elastic force.

As illustrated in FIG. 5, the two triangular frames 40 are arranged in the Y direction, and each triangular frame 40 has two biasing sections 3. More specifically, as illustrated in FIG. 3, the biasing sections 3 are arranged near the four corners of the plate section 21 of the sealing cover 20. In addition, the triangular frames 40 are coupled together in the Y direction so that the triangular frames 40 are integrated with each other.

As illustrated in FIG. 4, each support frame 40c is coupled to the plate section 21 via the corresponding biasing sections 3. In addition, each support frame 40c is coupled to the plate section 21 via a first engaging section 61 and a second engaging section 62.

The first engaging section 61 is an L-shaped engaging metal fitting, which engages with the support frame 40c so that the sealing cover 20 is not separated due to the pressing force applied by the biasing sections 3.

The second engaging section 62 is an engaging section that engages with the end portion of the sealing cover 20 which is opposite from the end portion where the first engaging section 61 is provided. The second engaging section 62 has an engagement shaft 66 being movable inside an elongated hole 67.

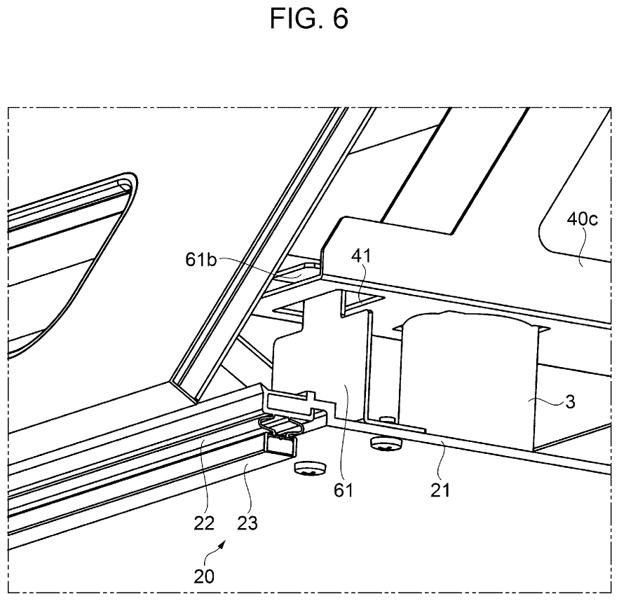

FIG. 6 is an enlarged perspective view of the first engaging section and some surrounding components, as viewed substantially from the lower side.

As illustrated in FIG. 6, the first engaging section 61 has a first end portion fixed to the plate section 21 with screws and a second end portion provided with an angled portion 61b. The angled portion 61b is disposed above a through-hole 41 of the support frame 40c, so that the angled portion 61b can be caught by a portion of the support frame 40c around the through-hole 41 even if the first engaging section 61 is pulled in the downward direction. As a result, the angled portion 61b helps to prevent the sealing cover 20 from falling off.

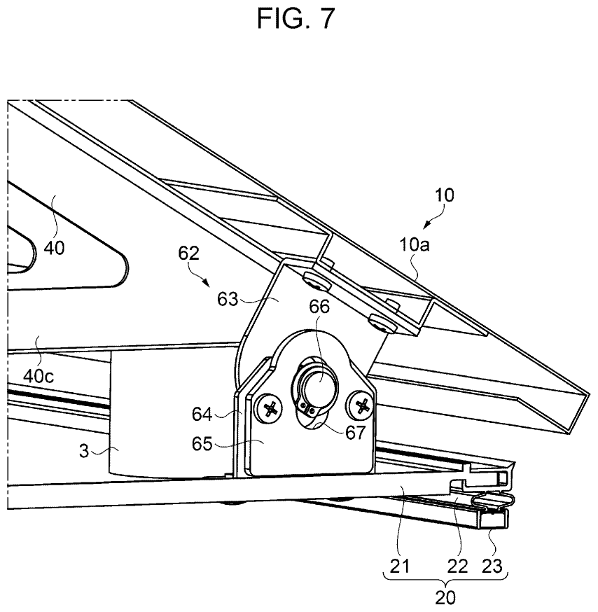

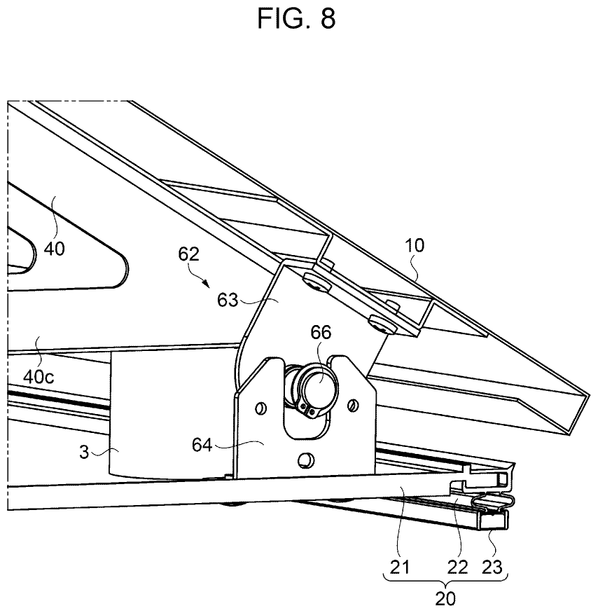

FIG. 7 is an enlarged perspective view of the second engaging section and some surrounding components. FIG. 8 is an enlarged perspective view of the second engaging section and some surrounding components with the third member removed.

As illustrated in FIG. 7, the second engaging section 62 includes a first member 63, a second member 64, a third member 65, and some other components.

The first member 63 is an L-shaped engaging metal fitting, a first end portion of which is fixed to the inner surface of the exterior cover 10 with screws. The first member 63 is attached at a second end portion thereof to an engagement shaft 66.

As illustrated in FIG. 8, the second member 64 is an L-shaped engaging metal fitting that mates with the first member 63. A first end portion of the second member 64 is fixed to the plate section 21 with screws. A second end portion of the second member 64 is provided with a U-shaped groove into which the engagement shaft 66 is fitted.

The third member 65 is a plate member provided with the elongated hole 67 and is in contact with and fixed to the second member 64 in the state illustrated in FIG. 8 with screws. In this way, the second engaging section 62 illustrated in FIG. 7 can be formed. When the sealing cover 20 is attached to the exterior cover 10, the angled portion 61b of the first engaging section 61 may be first inserted into the through-hole 41 of the support frame 40c and then the second engaging section 62 may be assembled.

When the lid 50 is opened, both the exterior cover 10 and the sealing cover 20 move together. When the lid 50 is closed, the sealing cover 20 can be brought into contact with the top plate 30 of the storage section 100 by an appropriate pressing force applied by the biasing sections 3. In this case, even if the sealing cover 20 is in uneven contact with the top plate 30, this unevenness can be compensated for by the buffering action of the biasing sections 3 arranged near the four corners of the plate section 21.

It can be said that the exterior cover 10 and the sealing cover 20 open and close in an interlocked manner with the biasing sections 3 therebetween. Each biasing section 3 is an elastic member provided between the exterior cover 10 and the sealing cover 20.

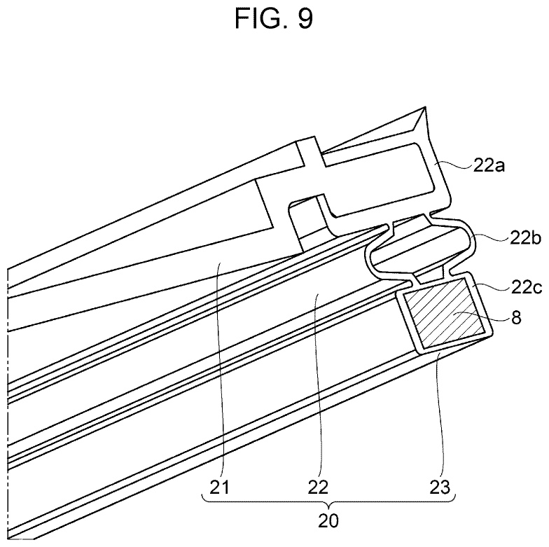

FIG. 9 is a perspective sectional view of the packing section and some surrounding components.

As illustrated in FIG. 9, the packing section 22 includes three stage components, that is, a mating section 22a, a cushioning section 22b, and a rectangular tube section 22c.

The mating section 22a mates with the periphery of the plate section 21.

The cushioning section 22b has a hollow diaphragm structure.

The rectangular tube section 22c has a hollow rectangular structure into which a magnet 8 is inserted. The lower surface of the rectangular tube section 22c serves as the abutment section 23. The magnet 8 is a rod-shaped permanent magnet. For example, the magnet 8 is a rubber magnet. In other words, the abutment section 23 has the magnet 8.

The packing section 22 is packing made of an elastic member formed by extruding resin. For example, the packing section 22 is made of vinyl chloride. However, the material of the packing section 22 is not limited to vinyl chloride and may be silicone resin or elastomer.

As illustrated in FIG. 3, the packing section 22 is formed in a rectangular ring shape on the periphery of the plate section 21, and the abutment section 23 is formed likewise.

In other words, the packing section 22 made of an elastic member is disposed between the plate section 21 and the abutment section 23.

Even if the sealing cover 20 is in uneven contact, this unevenness can be compensated for by the buffering action of the packing section 22 in addition to the buffering action of the biasing sections 3. Furthermore, since the magnet 8 of the abutment section 23 is attracted to the top plate 30 made of a magnetic material, the abutment section 23 can be brought into firm contact with the top plate 30. Note that the abutment section 23 may be made of a magnetic material, and the top plate 30 may be made of a magnet. Alternatively, both the abutment section 23 and the top plate 30 may be made of opposing magnetic materials having different poles. Anyway, the abutment section 23 and the top plate 30 can be brought into firm contact with each other by the magnetic force.

### Application to Sheet Manufacturing Apparatus

FIG. 10 is a schematic configuration diagram of a sheet manufacturing apparatus.

The storage section 100 configured above is suitably applicable to a sheet manufacturing apparatus 200.

The sheet manufacturing apparatus 200 is configured to manufacture paper sheets from pieces of, for example, waste paper through a dry process. The sheet manufacturing apparatus to which the storage section 100 is applicable is not limited to be of a dry type; alternatively, the sheet manufacturing apparatus may be of a wet type. In this embodiment, the dry process refers to a process that is not performed in a liquid but in the air such as the atmosphere.

As illustrated in FIG. 10, the sheet manufacturing apparatus 200 includes a first unit group 111, a second unit group 112, and a third unit group 113. The first unit group 111, the second unit group 112, and the third unit group 113 are collectively referred to as a processing section 150.

The first unit group 111, the second unit group 112, and the third unit group 113 are supported by a frame (not illustrated).

In FIG. 10, the directions in which paper pieces C, sheets P3, slit pieces S, and other unnecessary scraps are to be moved are indicated by white arrows. In the sheet manufacturing apparatus 200, the side to which the paper pieces C, a web W, the sheets P3, and other scraps to be transported may also be referred to as the downstream side, and the opposite side in the transport direction may also be referred to as the upstream side. Hereinafter, the collection of a plurality of paper pieces C is sometimes referred to simply as the paper piece C.

The sheet manufacturing apparatus 200 is configured to manufacture the sheets P3 from the paper pieces C. In the sheet manufacturing apparatus 200, the first unit group 111, the second unit group 112, and the third unit group 113 are arranged in this order from the −X-direction side toward the +X-direction side. The first unit group 111 is coupled to the storage section 100 described above.

When supplied from the storage section 100 to the first unit group 111 via an ejecting section 39, the paper pieces C are transported to the third unit group 113 through a pipe 92. Following this, the paper pieces C are subjected to defibrating and some other processes in the third unit group 113 to be fibers and then to be a mixture containing a binder. The mixture is transported to the second unit group 112 via a pipe 94. The mixture is formed into the web W and then a sheet P1 having a strip shape in the second unit group 112. The sheet P1 having a strip shape is cut into the sheets P3 in the first unit group 111.

The first unit group 111 includes a measuring section 15, a merging section 17, and the pipe 92. In the first unit group 111, those components are arranged in this order from the upstream side toward the downstream side. In addition, the first unit group 111 includes a first cutter 81, a second cutter 82, a tray 91, and a shredding section 95. Each of the first cutter 81 and the second cutter 82 cuts the sheet P1 having a strip shape into the sheets P3 having a predetermined shape. Furthermore, the first unit group 111 includes a water supplier 87. The water supplier 87 may be a water storage tank. The water supplier 87 supplies water for humidification to a first humidifier 85 and a second humidifier 86 (described later) in the second unit group through a water supply pipe (not illustrated).

The storage section 100 is configured to store the paper pieces C as the raw material of the sheets P3 and supply the paper pieces C toward the downstream side via the ejecting section 39. Each paper piece C contains fibers, such as cellulose fibers, and may be a shredded piece of waste paper. Humidified air is supplied to the inside of the storage section 100 from the second humidifier 86 disposed in the second unit group 112.

The paper pieces C are temporarily stored in the storage section 100 and then transported to the measuring section 15 via the ejecting section 39. The sheet manufacturing apparatus 200 may include a shredder disposed upstream of the storage section 100. This shredder may be configured to shred the paper pieces C and some other materials.

The measuring section 15 includes a sensor 15a and a supply mechanism (not illustrated). The sensor 15a is configured to measure the mass of paper pieces C. After the sensor 15a has measured the mass of the paper pieces C, the supply mechanism supplies these paper piece C to the merging section 17 at the downstream position. In this case, paper pieces C are measured by the sensor 15a of the measuring section 15 to have a predetermined mass, and then the supply mechanism collectively supplies these paper pieces C to the merging section 17 at the downstream position.

The sensor 15a can employ either a digital or analog weighing mechanism. More specifically, the sensor 15a may be a physical sensor, such as a load cell, a spring balance, or a balance scale. In this embodiment, the sensor 15a is a load cell. The predetermined mass of the paper pieces C measured by the sensor 15a may be approximately several to several tens of grams.

The process in which the measuring section 15 measures the mass of paper pieces C and supplies the paper pieces C is performed in units of batches. In other words, the paper piece C is supplied from the measuring section 15 to the merging section 17 in an intermittent manner. The measuring section 15 may include a plurality of combinations of sensors 15a and supply mechanisms. In addition, the measuring section 15 may operate the plurality of sensors 15a at different timings, thereby performing the mass-measuring and supplying processes with a higher efficiency. The sheet manufacturing apparatus 200 may include two sensors 15a and supply mechanisms attached to the respective sensors 15a. Accordingly, the paper pieces C are transported alternately from two pairs of sensor 15a and supply mechanism to the merging section 17.

The merging section 17 merges the paper pieces C supplied from the measuring section 15 with fine scraps of the slit pieces S supplied from the shredding section 95. Details of the slit pieces S and the shredding section 95 will be described later. The paper pieces C mixed with the fine scraps are fed from the merging section 17 into the pipe 92.

After having flown into the pipe 92, the paper pieces C are attracted by the suction airflow generated by a defibrator 33 at the downstream position, thereby being transported from the first unit group 111 to the third unit group 113 via the second unit group 112.

The third unit group 113 includes the defibrator 33, which is of a dry type, a separator 34, a pipe 93, a mixer 36, and the pipe 94. In addition, the third unit group 113 includes a pipe 96 branching from the separator 34, a waste powder collector 46 to which the pipe 96 is coupled, and a power source 69.

After having passing through the pipe 92, the paper pieces C flow into the defibrator 33. The defibrator 33 is configured to defibrate the paper pieces C supplied from the measuring section 15 into fibers through a dry process. The defibrator 33 can employ a known defibrating mechanism.

The defibrator 33 may have a configuration, for example, described below. The defibrator 33 includes a stator and a rotor. The stator has a substantially cylindrical inner surface. The rotor is mounted inside the stator and rotates along the inner surface of the stator.

The paper pieces C are positioned between the inner surface of the stator and the rotor and are defibrated by a shearing force generated therebetween. As a result, entangled fibers contained in the paper pieces C are disentangled. In this way, the paper pieces C are made into the fibers, which are then transported to the separator 34.

The separator 34 is configured to separate the fibers from one another. The separator 34 then removes ingredients contained in the fibers which are unnecessary for the manufacture of the sheet P3. For example, the separator 34 separates the fibers into relatively long fibers and relatively short fibers. The separator 34 then removes the relatively short fibers because such fibers may cause a lowered strength of the sheets P3. In addition, the separator 34 also removes colorants, additives, or some other chemical components contained in the paper pieces C. The separator 34 can employ a disk mesh technique or other known technique. Humidified air is supplied to the inside of the separator 34 from the second humidifier 86 of the second unit group 112.

After short fibers that are not suitable for recycling and waste powder such as colorants contained in the paper pieces have been removed from the fibers, these defibrated fibers are transported to the mixer 36 through the pipe 93 by an airflow generated by a blower (not illustrated) disposed at the tip end of an airflow pipe 35.

The gas containing the waste powder passes through the pipe 96 and flows into a filter 37 of the waste powder collector 46. When the gas flows into the filter 37, waste powder is removed from the gas by the filter 37. The resultant gas is then discharged to the outside via the exhaust port. The removed waste powder is collected inside a waste box 38. The waste powder collector 46 may be a bag filter, which includes a blower 43 that generates an exhaust flow and a compressor 44 that generates compressed air for use in cleaning the filter 37.

The mixer 36 mixes a powder additive, such as a binder, with the fibers in the air to form the mixture. The mixer 36 includes a powder supply mechanism 19. The powder supply mechanism 19 includes a hopper therein. The powder supply mechanism 19 is equipped with a powder supply container 29. Although not illustrated, the mixer 36 includes, in addition to the powder supply mechanism 19, a flow path through which the fibers are to be transported, a valve, and a fan.

The hopper sends out powder of the binder supplied from the powder supply container 29 into the flow path. The sheet manufacturing apparatus 200 may use starch as the binder for the fibers. A valve (not illustrated) adjusts the flow rate, namely, the mass of the binder supplied from the hopper into the flow path. As a result, the mixing ratio between the fibers and the binder is adjusted. In addition to the powder supply container 29 and the powder supply mechanism 19 that supply the binder, the mixer 36 may include similar structures that supply a colorant, an additive, or some other chemical substances. The mixer 36 uses a fan to mix the binder, other substances, and the fibers in the air to form the mixture while transporting the fibers to the downstream side by using a generated airflow. The mixture flows from the mixer 36 into the pipe 94.

The power source 69 includes a controller 45 and a power supply device (not illustrated) that supplies electric power to the sheet manufacturing apparatus 200. The power source 69 distributes externally supplied electric power to individual components constituting the sheet manufacturing apparatus 200.

The controller 45 controls each section of the sheet manufacturing apparatus 200 in a centralized manner. The controller 45 may be connected to a computer 76. The computer 76 is, for example, a notebook computer.

The second unit group 112 deposits and compresses the mixture containing the fibers to form the sheet P1 having a strip shape as a recycled paper sheet. The second unit group 112 includes a depositor 48, a first transport section 83, a second transport section 84, the first humidifier 85, the second humidifier 86, a drainer 88, and a forming section 70.

In the second unit group 112, the depositor 48, the first transport section 83, the second transport section 84, the first humidifier 85, and the forming section 70 are arranged in this order from the upstream side toward the downstream side. The second humidifier 86 is disposed below the first humidifier 85.

The depositor 48 deposits the mixture containing the fibers in the air to generate the web W. The depositor 48 includes a drum member 53, a blade member 55 disposed inside the drum member 53, a housing 51 that accommodates the drum member 53, and an aspirator 59. The mixture is fed into the drum member 53 through the pipe 94.

The first transport section 83 is disposed below the depositor 48. The first transport section 83 includes a mesh belt 83a and five tension rollers (not illustrated) between which the mesh belt 83a is stretched. The aspirator 59 is disposed opposite the drum member 53 with the mesh belt 83a therebetween in the direction along the Z axis.

The blade member 55 is disposed inside the drum member 53 and is driven to rotate by a motor (not illustrated). The drum member 53 may be a semi-columnar sieve. A side surface, which faces downward, of the drum member 53 is provided with a mesh having the function of a sieve. The drum member 53 allows particles of the fibers, mixtures and the like which are smaller than the mesh opening of the sieve to pass therethrough from the inside to the outside.

The mixture is discharged to the outside of the drum member 53 while being stirred by the blade member 55 rotating inside the drum member 53. Humidified air is supplied to the inside of the drum member 53 from the second humidifier 86.

The aspirator 59 is disposed below the drum member 53. The aspirator 59 sucks the air inside the housing 51 via a plurality of holes formed in the mesh belt 83a. The air can pass through the plurality of holes in the mesh belt 83a, whereas the fibers, the binder, and some other substances contained in the mixture cannot easily pass therethrough. As a result, the mixture that has been discharged to the outside of the drum member 53 is sucked in the downward direction together with the air. The aspirator 59 may be a known suction device, such as a blower.

The mixture is dispersed in the air inside the housing 51 and is deposited on the upper surface of the mesh belt 83a due to gravity and the suction force applied by the aspirator 59, thereby forming the web W.

The mesh belt 83a, which may be an endless belt, is stretched between the five tension rollers. The mesh belt 83a moves counterclockwise in FIG. 10 in response to the rotation of the tension rollers. As a result, the mixture is continuously deposited on the mesh belt 83a to form the web W. The web W contains a relatively large amount of air and is soft and swollen. The first transport section 83 transports the formed web W in the downstream direction in response to the rotation of the mesh belt 83a.

The second transport section 84 transports the web W at the downstream position of the first transport section 83, instead of the first transport section 83. The second transport section 84 separates the web W from the upper surface of the mesh belt 83a and then transports the web W to the forming section 70. The second transport section 84 is disposed above the transport path of the web W and slightly upstream of the initial point from which the mesh belt 83a is to be moved in the downward direction. The +X-direction side of the second transport section 84 overlaps the −X-direction side of the mesh belt 83a in the vertical direction. The second transport section 84 includes a transport belt, a plurality of rollers, and a suction mechanism, all of which are not illustrated. The transport belt is provided with a plurality of holes that allow air to pass therethrough. The transport belt is stretched between the plurality of rollers and moves in response to the rotation of the rollers.

The suction mechanism of the second transport section 84 generates negative pressure to bring the upper surface of the web W into contact with the lower surface of the transport belt. When the transport belt moves in this state, the web W is transported to the downstream side while kept in contact with the transport belt.

The first humidifier 85 humidifies the web W containing the fibers deposited by the depositor 48 of the second unit group 112. More specifically, the first humidifier 85, which is, for example, a mist humidifier, supplies mist M from below to the web W being transported by the second transport section 84, thereby humidifying the web W. The first humidifier 85 is disposed below the second transport section 84 and faces, in the direction along the Z axis, the web W being transported by the second transport section 84. The first humidifier 85 can employ a known humidifying device, such as an ultrasonic humidifying device.

By humidifying the web W with the mist M, the function of the starch serving as a binder is improved, so that the strength of the sheets P3 increases. In addition, since the web W is humidified from below, droplets derived from the mist are prevented from falling onto the web W. Furthermore, since the web W is humidified from the side opposite to the contact surface between the transport belt and the web W, sticking of the web W to the transport belt is reduced. The second transport section 84 then transports the web W to the forming section 70.

The forming section 70 includes two processing rollers 71 and 72. Both the processing rollers 71 and 72 press the web W containing the fibers to form the sheet P1 having a strip shape. The processing rollers 71 and 72 forming a pair each has a built-in electric heater that raises the temperature of the roller surface thereof.

Each of the processing rollers 71 and 72 is a substantially columnar member. Both the processing rollers 71 and 72 are arranged with the rotation shafts thereof extending along the Y-axis. The processing roller 71 is disposed substantially above the transport path of the web W, whereas the processing roller 72 is disposed substantially below the transport path. The processing rollers 71 and 72 are disposed with a gap between the circumferential surfaces thereof. The size of the gap corresponds to the thickness of a sheet P3 to be manufactured.

Each of the processing rollers 71 and 72 is driven to rotate by a stepping motor (not illustrated). The web W is fed to the downstream side while being pressed and heated between the processing rollers 71 and 72. In this case, the web W continuously passes through the forming section 70 and is press-formed while being heated. By using both the processing rollers 71 and 72 as a pair of forming members, the web W can be efficiently heated and pressed.

The web W is soft and contains a large amount of air. When the web W passes through the forming section 70, the amount of air in the web W decreases and the fibers therein are bound together by the binder. In this way, the web W is formed into the sheet P1 having a strip shape. The sheet P1 having a strip shape is then transported to the first unit group 111 by transport rollers (not illustrated).

The second humidifier 86 is disposed below the first humidifier 85. The second humidifier 86 can employ a known evaporative type of humidifying device. One example of such an evaporative type of humidifying device is a humidifying device that generates humidified air by blowing air onto, for example, a wet non-woven fabric to vaporize the moisture.

The second humidifier 86 humidifies a predetermined region inside the sheet manufacturing apparatus 200. In the predetermined region, one or more of the storage section 100, the separator 34, and the drum member 53 of the depositor 48 are disposed. Specifically, the second humidifier 86 supplies the humidified air to the above region through a plurality of pipes (not illustrated). In this configuration, the supplied humidified air decreases the electrostatic charge of the paper pieces C, fibers, and some other substance, thereby suppressing adhesion of the paper pieces C, the fibers, and the substances to members due to static electricity. In such a humidifying method, if the air is dry before the humidification, a large amount of moisture is vaporized; if the air is wet before the humidification, a small amount of moisture is vaporized. Therefore, when a sufficiently long time passes, the region to which the humidified air has been supplied is maintained at a substantially constant humidity. In addition, since the sealing cover 20 tightly closes the insertion port 31, moisture is less likely to leak from the storage section 100 via the insertion port 31 even when the second humidifier 86 humidifies the storage section 100 to regulate the humidity thereof. This configuration can control the humidity of the storage section 100 more easily than a configuration in which the insertion port 31 is exposed.

The drainer 88 may be a drainage tank. The drainer 88 collects and stores the waste moisture after water moisture has been used by the first humidifier 85, the second humidifier 86, and some other components. The drainer 88 is detachable from the sheet manufacturing apparatus 200 as necessary for the purpose of dumping the collected water therefrom.

After having been transported to the first unit group 111, the sheet P1 having a strip shape reaches the first cutter 81. The first cutter 81 cuts the sheet P1 having a strip shape in a direction, such as the direction along the Y axis, intersecting the transport direction. The first cutter 81 cuts the sheet P1 having a strip shape into cut sheets P2. The cut sheets P2 are then transported from the first cutter 81 to the second cutter 82.

The second cutter 82 cuts each cut sheet P2 in a direction parallel to the transport direction. More specifically, the second cutter 82 cuts both side portions, in the direction along the X axis, of each cut sheet P2. In this way, each cut sheet P2 can be formed into the sheets P3 having a predetermined shape, such as an A4- or A3-sized sheet.

When the second cutter 82 cuts the cut sheets P2 into the sheets P3, the slit pieces S are produced as scraps. The slit pieces S are transported in the downward direction to the shredding section 95, which may be a shredder. The shredding section 95 shreds each slit piece S into fine scraps, which are then supplied to the merging section 17. Optionally, a mechanism is provided between the shredding section 95 and the merging section 17 to measure the weight of fine scraps of slit pieces S and supply these fine scraps to the merging section 17.

The sheets P3 are transported in a substantially upward direction and are stacked on the tray 91. In this way, the sheets P3 can be manufactured by the sheet manufacturing apparatus 200. Each sheet P3 is usable, for example, as a replacement for copy paper.

In other words, the sheet manufacturing apparatus 200 includes a storage section 100 that stores paper pieces C, and a processing section 150 that uses the paper pieces C as a raw material to manufacture recycled paper through a dry process.

What is claimed is:

1. A sheet manufacturing apparatus comprising:
a storage section that stores paper pieces;
a processing section that uses the paper pieces as a raw material to manufacture recycled paper through a dry process;
an exterior cover; and
a sealing cover that tightly closes an insertion port of the storage section, wherein
the exterior cover and the sealing cover open and close in an interlocked manner.

2. The sheet manufacturing apparatus according to claim 1, further comprising a biasing section that presses the sealing cover toward the insertion port when the exterior cover is closed.

3. The sheet manufacturing apparatus according to claim 1, wherein
the sealing cover includes
an insertion port cover that covers the insertion port,
an abutment section disposed on a periphery of the insertion port cover and attracted onto a portion of the storage section around the insertion port by a magnetic force.

4. The sheet manufacturing apparatus according to claim 1, further comprising a humidifying device of an evaporative type, wherein
the storage section is humidified by the humidifying device.

5. The sheet manufacturing apparatus according to claim 1, wherein
the exterior cover is rotatably attached to a main body of the sheet manufacturing apparatus via a rotation shaft, and
the sealing cover in an open state is attached to the main body via the exterior cover.
